(19) United States
(12) Patent Application Publication
(10) Pub. No.: US 2010/0193303 A1
(43) Pub. Date: Aug. 5, 2010

(54) BRAKE SPIDER WELDMENT AND ANCHOR PIN ASSEMBLY

(75) Inventors: Shen LI, Troy, MI (US); Larry S. JEVNIKAR, Portage, MI (US); Troy Allen FLODIN, Portage, MI (US); Jeff JONES, Battle Creek, MI (US); Dan BANKS, Climax, MI (US)

Correspondence Address: CROWELL & MORING LLP;INTELLECTUAL PROPERTY GROUP, P.O. BOX 14300, WASHINGTON, DC, 20044-4300, US

(73) Assignee: Bendix Spicer Foundation Brake LLC, Elyria, OH (US)

(21) Appl. No.: 12/366,070

(22) Filed: Feb. 5, 2009

(51) Int. Cl. F16D 65/09; F16D 51/18; B60B 35/00; B21D 53/88

(52) U.S. Cl. 188/206 A; 188/330; 301/124.1; 29/897.2

(57) ABSTRACT

An improved brake spider and anchor pin assembly in which weight, cost, manufacture, axle installation and maintenance is improved over prior brake spider designs. The improved brake spider is built up from light weight, relatively inexpensive stampings which are joined together, for example by welding, to form a strong built-up brake spider component. In one embodiment, two steel stampings formed with flanges and stamped strengthening ribs are welded together to form a hollow, structure which has the strength to withstand high brake force loads and large numbers of brake cycles. The built up brake spider may include one or more captured inserts in the form of anchor pin assemblies and a brake actuator rod pass-through support. The anchor pin insert may be in the form of a trunion having a middle section with a greater diameter than corresponding holes in the shell plates to preclude axial motion.

### BACKGROUND AND SUMMARY OF THE INVENTION

The present invention relates to brakes used on, for example, commercial truck or trailer axles, and includes a brake support known as a brake spider which transfers braking torque from a brake drum to an axle. An associated anchor pin assembly is also disclosed.

A brake spider is a support commonly used for a brake having dual webbed brake shoes, typically utilized at the wheel end of a heavy duty truck or trailer axle (such heavy duty axles and brakes are used on trucks and other heavy duty vehicles, collectively referred to as “commercial vehicles”). The brake spider is affixed to the vehicle axle, typically by welding or bolting. As shown in FIG. 10, the brake spider 100 is fitted over and welded to axle housing 110. The spider 100 can have two holes at one end which receive anchor pins 130. The anchor pins 130 provide anchor points for the brake shoes 140, and provide surfaces about which the brake shoes 140 may pivot as the brake shoes are pushed outward to engage the inner surface of a brake drum (not illustrated). Near the opposite end of the brake spider 100, there is a hole which permits an actuator rod (also referred to as a camshaft) 160 from a brake actuator located inboard of the brake to pass through the spider (the brake actuator for the near end of the axle is not illustrated; partially visible brake actuator 165 is shown at the far end of axle). The actuator rod 160 is rotated by the brake actuator in order to rotate a cam 170, which in turn displaces the adjacent ends 180 of the brake shoes 140 outward, thereby forcing the brake shoes 140 into engagement with the brake drum to slow the vehicle.

Previously, brake spiders typically have been steel components, primarily steel forgings. Stamped steel and cast iron have also been used. This is a result of the need for a strong, rigid component that can withstand repeated application of braking forces, a high temperature environment, and a very high number of fatigue cycles. In addition, steel has been used because a large fraction of brake spiders are welded directly to their axles to ensure a strong, permanent fixture, and steel is best suited to welding in an industrial production environment. In contrast, ductile cast iron castings have not been widely used in this welded-on version of the application, as ductile cast iron is well known to be unsuitable for welding in production environments. This is due to the fact that a significant portion of ductile cast iron's extraordinarily high carbon content will tend to precipitate out of the liquid metal solution in and near the weld pool, resulting in undesirable metallurgy local to the weld joint which weakens the joint. On occasion, ductile cast iron has been used for welded-on brake spiders, however, this is usually only possible with undesirable compromise or complication, e.g., by making the ductile cast iron spider extraordinarily large and heavy (to provide sufficient material to absorb the expected brake loads) or by using a composite structures of ductile cast iron and steel components, such as the brake spider disclosed in U.S. Pat. No. 5,301,776. In the U.S. Pat. No. 5,301,776 disclosure, a steel core which can be welded to an axle is incorporated into a spider by casting ductile cast iron around the steel core.

Other alternative brake spider forms have included thick steel sheets which have been formed by stamping, rather than forging, such as the brake spider on U.S. Pat. No. 4,445,597. This brake spider must be formed from very heavy gauge steel plate in order to withstand braking forces, and as shown in FIGS. 1-3 of U.S. Pat. No. 4,445,597, is provided with heavy reinforcing ribs. Further, despite the thickness of the plate, as shown in FIGS. 1-2 of U.S. Pat. No. 4,445,597, the brake spider itself is not relied upon to support the spider's anchor pin(s) and/or its cam bushing, but instead bolted-on bearing plates must be added to the brake spider, adding cost and complexity to the design.

Regardless of their materials, the prior art brake spiders have been undesirably heavy, either as thick, solid steel forgings, heavy ductile iron castings, or thick steel sheets. These spiders have all also suffered from the problem of being relatively expensive to form, whether due to the costs associated with forging (forging dies and process equipment), ductile iron casting (molding equipment and material processing for casting, as well as additional costs associated with imbedding steel inserts into the castings) or stamping thick steel plates (special thick-plate stamping dies and high-powered stamping machines). As high fuel prices continue to drive vehicle operating costs higher, there is a strong demand for use of lighter weight components to decrease overall vehicle weight. However, merely shaving weight off of existing brake spider designs is not a viable approach, as removing material typically reduces strength and stiffness of these critical brake components. Accordingly, a completely new approach to brake spider design is needed to provide both significantly lighter spider weight, while still providing a spider which is sufficiently strong to survive high braking loads and has sufficient fatigue life to be able to survive a high number of duty cycles in commercial vehicle service.

In view of the foregoing, it is an objective of the present invention to provide an improved brake spider and anchor pin assembly in which weight, cost, manufacture, axle installation and maintenance is improved over prior brake spider designs.

In addressing these and other objectives, the present invention provides a solution to the problems of the prior art by forming a brake spider from light weight, relatively inexpensive stampings which are joined together, for example, by relatively inexpensive conventional welding techniques, to form a strong built-up brake spider component.

In a preferred embodiment, two steel stampings are formed with flanges and stamped strengthening ribs, and are welded together to result in a hollow, reinforced structure which has the strength to withstand high brake force loads and large numbers of brake cycles, with a fraction of the material cost and weight. Further, additional ribs and/or fillet plates may be included, for example, within the hollow portion of the built-up brake spider, in order to further strengthen the spider.

The thin stampings for such a weldment may be easily and relatively inexpensively formed by, for example, stamping thin steel plate stock in low-power steel stamping presses, and then welding about the periphery of the joint line between the two stamped halves of the spider to provided a hollow, light weight, strong and rigid brake spider. Alternative jointing approaches will be readily apparent to those of ordinary skill in the art, such as by including flanges about the periphery of the stamped halves of the brake spider, using fasteners such as bolts, adhesives, rivets, pinning, brazing, and/or connection by some form of mechanical lock. The flanges may meet to abut one another essentially exactly edge-to-edge, or alternatively may overlap one another, as long sufficient mating surfaces for joining the flanges together are provided (for example, by welding). In another embodiment, one or more of the thin stampings may have extensions formed as part of their jointing flanges. Such extensions may be used for mounting other brake components, such as dust shields.

In a preferred embodiment, prior to joining the two thin stampings, one or more inserts may be placed between and captured by the stampings. The insert(s) would protrude from holes in at least one of the stampings to serve as anchor pin locators and/or brake actuator rod bushings. The inserts preferably would have raised regions, such as an external ring or a plurality of radial tabs which both limit the depth of insertion of the insert(s) through the stampings as the brake spider stampings are being assembled, and after the brake spider weldment is formed, also serve to support the surfaces of the stampings, effectively further strengthening the brake spider weldment and providing additional lateral crush resistance.

The use of one or more captured inserts to support the highly localized loads at the locations of the anchor pins and the brake actuator rod pass-through permits the spider stampings to be formed without being made particularly thick and heavy in the immediate vicinity of the anchor pins and brake actuator rod pass-through. The insert(s) may be retained within the brake spider halves solely by virtue of being captured therebetween, or may be secured by being pressed into at least one of the spider halves in an interference fit or by welding about the periphery of the insert/spider plate interface.

The reinforcing insert(s) for the one or more anchor pins and/or the brake actuator rod pass-through may be formed as bushing through which an anchor pin or brake actuator rod passes, or the inserts may be provided with bearing bushings, such as replaceable bushings, on their inner surfaces which serve as the contact surfaces for the anchor pin(s) and/or actuator rod. This arrangement permits the insert to be reliably located and secured against drifting out of the brake spider, in a manner which has low cost and simplifies production. Further, the insert(s) for the anchor pins may be tubular elements which receive an anchor pin which passes through the brake spider, or the insert itself may include the anchor pin, i.e., the anchor pin extends axially outward from the outer face of the brake spider. In this latter embodiment, the anchor pin insert is preferably secured to at least one of the brake spider halves, such as by welding.

It may be possible to eliminate inserts entirely, relying entirely on the edges of the holes in the steel plates to provide sufficient bearing surfaces for anchor pins and/or actuator rods that pass through the spider. In one embodiment, anchor pins located directly into their corresponding holes in the brake spider plates are provided. In one embodiment, snap rings or similar retaining devices located about the outer circumference of the anchor pins, and located such that when positioned between opposing halves of the brake spider, the snap rings abut the inner surfaces of each spider half, precluding axial movement of the anchor pin. As a preferred alternative to the use of snap rings, the anchor pins may be formed with a trunion shape, i.e., with an outer circumference which is larger than the receiving holes in the spider halves in the region between the plates, and a smaller outer circumference in the region outside the steel halves. The width of the larger diameter portion of the anchor pin would be sufficient to permit the shoulders of the large diameter portion to contact the inner surfaces of the facing brake spider plate halves, preferably full 360 degree contact about the shoulders. Such an trunion-shaped anchor pin would eliminate the need for additional components such as snap rings, lowering cost and simplifying brake spider manufacture. The anchor pins optionally may be locally supported by reinforcing rings or plates at the pin pass-through hole in the brake spider. For example, a simple ring-shaped plate welded to the surface of the brake spider would reinforce the thin spider plate at low cost, potentially avoiding any need to increase the thickness of the spider plate to withstand directly-applied anchor pin loads during operational service.

The present invention's use of steel as compared to ductile cast iron permits the use of inexpensive and rapid conventional welding processes to join brake spider weldment directly to the axle, as is common on trailer axle ends. Alternatively, the weldment may be directly fastened to the axle, for example to a bolting flange on the axle using fasteners which pass through the weldment, as is common on drive and steer axle ends. The use of relatively thin steel stampings also permits the addition of a flange to the brake spider weldment for bolting on accessories such as a dust shield at virtually no cost.

The present invention thus provides a brake spider with a hollow, closed-box cross-section which minimizes total spider weight while maintaining high strength and stiffness, and does so at low cost using simple, readily available manufacturing processes.

Other objects, advantages and novel features of the present invention will become apparent from the following detailed description of the invention when considered in conjunction with the accompanying drawings.

### BRIEF DESCRIPTION OF THE DRAWINGS

FIGS. 1a and 1b are oblique views of outboard and inboard sides, respectively, of a built-up brake spider in accordance with an embodiment of the present invention.

FIGS. 2a and 2b are oblique views of front and back sides of the stamping forming the outboard side of the built-up brake spider shown in FIG. 1a.

FIGS. 3a and 3b are oblique views of front and back sides of the stamping forming the inboard side of the built-up brake spider shown in FIG. 1b.

FIG. 4 is a cross-section view of the built-up brake spider shown in FIG. 1 at plane A-A.

FIG. 5 is a cross-section view of an anchor pin and/or brake actuator rod insert captured between inboard and outboard sides of a built-up brake spider in accordance with an embodiment of the present invention.

FIG. 6 is a cross-section view of an anchor pin and/or brake actuator rod bearing surface formed in a shell plate of a built-up brake spider in accordance with an embodiment of the present invention.

FIG. 7 is an oblique view of a built-up brake spider in accordance with an embodiment of the present invention which includes holes through which fasteners may pass to secure the built-up brake spider to an axle end.

FIGS. 8a and 8b are oblique views of outboard and inboard sides, respectively, of a built-up brake spider in accordance with another embodiment of the present invention.

FIG. 8c is an oblique view of a built-up brake spider having mutually-complementary flange portions in accordance with another embodiment of the present invention.

FIGS. 9a-9b are oblique and cross-section views of brake spiders in accordance with embodiments of the present invention having anchor pins with snap rings and a trunion shape, respectively.

FIG. 10 is an oblique view of a brake assembly containing a prior art brake spider.

### DETAILED DESCRIPTION OF THE DRAWINGS

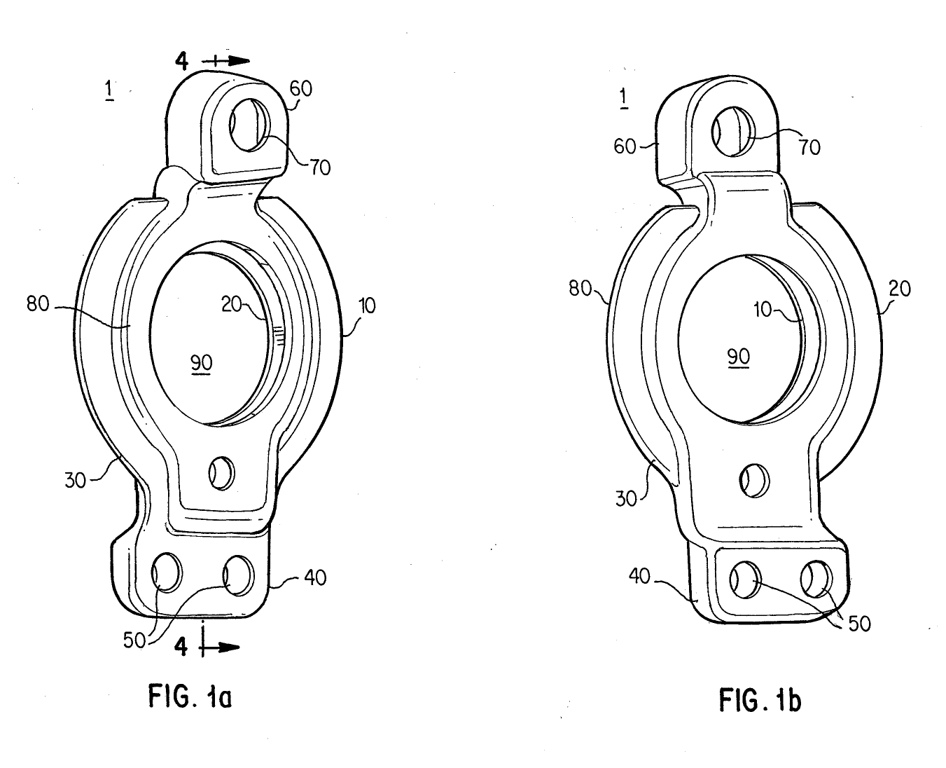

FIGS. 1a and 1b show outboard and inboard, respectively, oblique views of a built-up brake spider 1 in accordance with an embodiment of the present invention, in which an outer shell plate 10 and an inner shell plate 20 are joined by welding along a seam 30 formed at mutually-contacting edge surfaces. In this embodiment, the shell plates have been formed by stamping of steel, however, other forming techniques, such as forging and hydroforming, made be used to form the shells, and the shells made be formed from materials other than plain steel, such as aluminum or dual-phase steel. This embodiment also illustrates joining of the shell plates along mutually-contacting edges, however the invention is not limited solely to such edge configurations, but includes any arrangements which permit the joining of adjacent portions of the shells, including abutting and/or overlapping surfaces and edges, and use of any joining technique, such as welding, brazing, adhesives, crimping, and/or mechanical fasteners such as rivets, screws and bolts. In addition, the invention is not limited to joining by methods such as welding only at the mutually-contacting surfaces of the shell plates, but may include any method of joining which permits the formation of a built-up brake spider, such as the combination of shell plates with edges which meet but are not joined (for example, interlocking or flanged edges which are not welded to one another) and the use of fasteners in other regions of the shell plates which hold the shell plates together so as to keep the shell plate edges in contact with one another.

At an anchor pin end 40 of the built-up brake spider 1, a deep recess area of the inboard shell plate 20 is covered by a flat portion of the outboard shell plate 10 to form a box area in which anchor pin apertures 50 are located. Similarly, at an opposite brake actuator rod end 60 of the built-up brake spider, holes 70 are provided to accommodate a brake actuator rod (not illustrated for clarity). In addition to the deeply drawn portions of the outboard and inboard shell plates, the shell plates in this embodiment are provided with reinforcing ribs such as embossed areas 80 which strengthen the shell plates. At the center of the shell plates, a large aperture 90 is provided through which an axle end (not illustrated) passes when the brake spider 1 is located on the axle. In this embodiment, no bolting holes are provided about aperture 90 because this spider is intended to be welded to an axle end, as opposed to being secured to the axle end with fasteners.

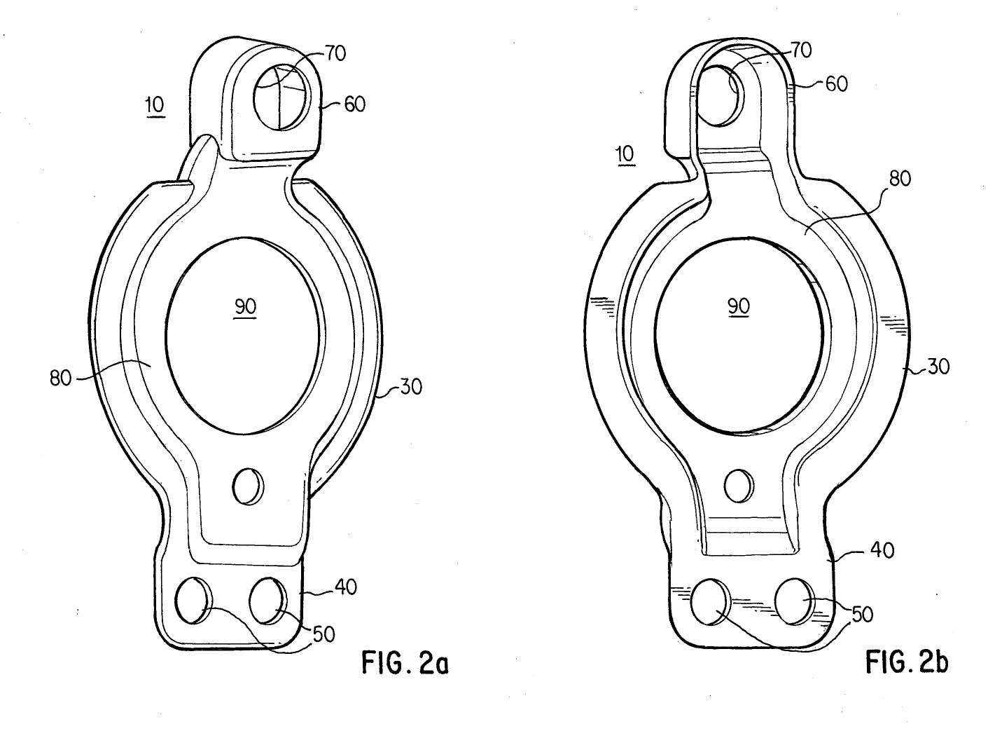

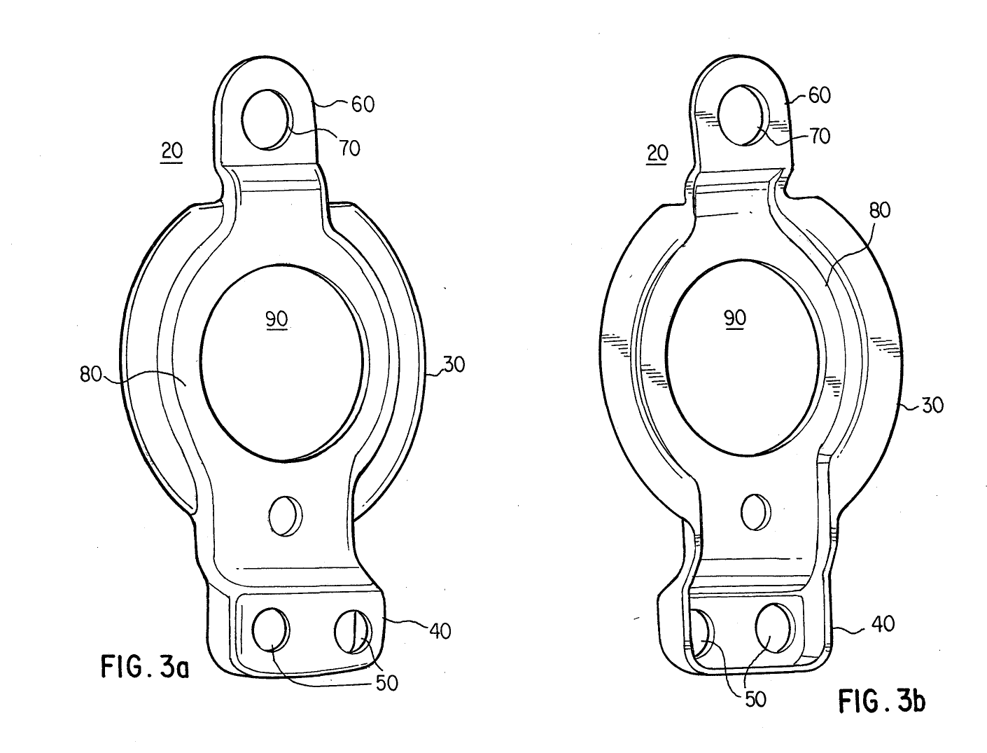

FIGS. 2a and 2b provide oblique views of both the outer and inner surfaces of the outboard shell plate 10 of FIG. 1, showing in particular the peripheral edge 30 which is shaped to conform to the corresponding peripheral edge of the opposite inboard shell plate 20. As can be see in FIG. 2b, as a result of the stamping operation, the inside surface of the outboard shell plate 10 is concave in the regions about the brake actuator rod hole 70 and the axle end aperture 90, helping create a “box” structure which strengthens the built-up brake spider. FIGS. 3a and 3b provide similar views of the inner and outer surfaces of the inboard shell plate 20. As in FIG. 2b, the FIG. 3b view of the inner surface of inboard shell plate 20 shows the concave regions about the axle end aperture 90 and about the anchor pin apertures 50.

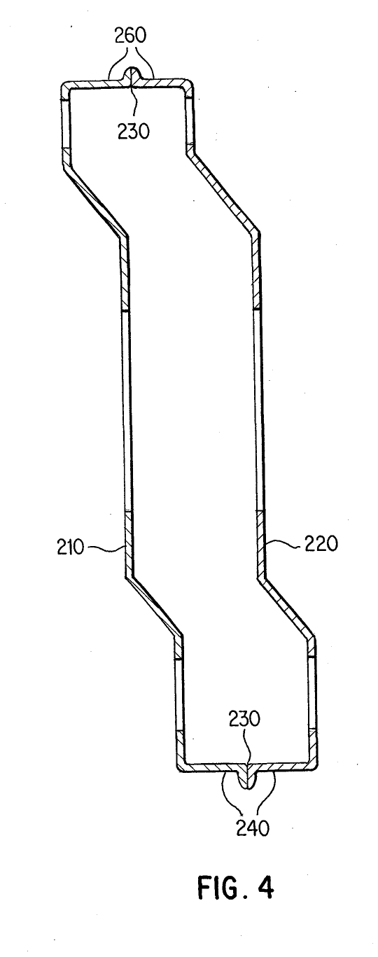

FIG. 4 shows an alternative embodiment of the built-up brake spider, in a cross-section generally corresponding to the line A-A in FIG. 1. In this embodiment, rather than having the deep drawn portions of the shell plates being positioned entirely on one or the other plate, the stamped plates 210 and 220 are each formed with approximately one-half of the depth of anchor pin ends 240 and brake actuator rod ends 260, such that when the peripheral edge flanges 230 are welded together, the full desired depth of the box-shaped ends 240, 260 are formed. It should also be apparent that the peripheral edge flanges 230 may be extended a sufficient distance to accommodate fasteners, such as screws and nuts, as an alternative approach to joining the halves of the built-up brake spider together.

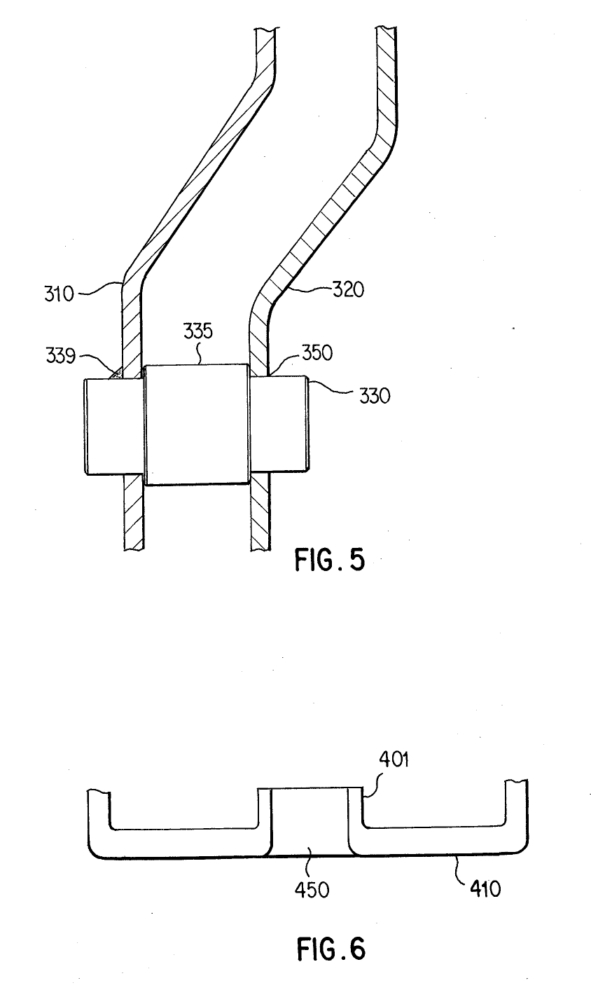

FIG. 5 shows a cross-section view of one embodiment of an anchor pin assembly, in which an anchor pin insert 330 is placed between outboard sheet plate 310 and inboard sheet plate 320, and remains captured therebetween when the sheet plates 310, 320 are joined together by a radial projection 335 which has a larger outer diameter than anchor pin holes 350. Alternatively, one or more radial projections which are relatively thin in the axial direction, i.e., which do not span the entire distance between the inner surfaces of shell plates 310, 320, may be used to help locate and retain the anchor pin insert within the brake spider. A further alternative would be to use an anchor pin insert with an outer diameter approximately the same size as the anchor pin holes in the shell plates, and secure the insert in place by pressing and/or a positive fixation technique, such as welding, or by the use of snap rings about the outer circumference of the trunion which prevent lateral movement of the pin out of the brake spider. The brake spider shells may also be supported in the immediate vicinity of the receiving holes 350 by a reinforcing ring or plate, which may be either integrally formed with the plate or formed by a separate part which is affixed to the plate, for example by welding.

The anchor pin insert 330 may be a solid component with an anchor pin projection extending outward from the face of the outboard side of the brake spider, or may have a tube shape to accommodate an anchor pin passing through the brake spider (not illustrated) or to receive a bushing insert (also not illustrated) in which an anchor pin may pass. The anchor pin insert may be secured by welding, such as by weld bead 339 shown in FIG. 5, or as those of ordinary skill in the art will recognize, by any other means which reliably retains the insert. While the foregoing discussion has focused on the anchor pin assembly, it is to be understood that the same types of inserts and securing techniques may be used for the brake actuator rod passage through the opposite end of the built-up brake spider.

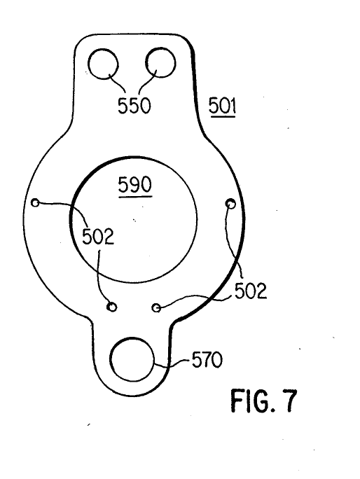

FIG. 6 is a cross-section view of an anchor pin and/or brake actuator rod bearing surface formed in a shell plate in accordance with an embodiment of the present invention. The formation of a bearing flange 401 in a shell plate 410 about an anchor pin hole 450 would permit the built-up brake spider to receive and support an anchor pin passing through the shell plate, without the need for an insert. This arrangement would minimize cost and assembly steps during manufacture.

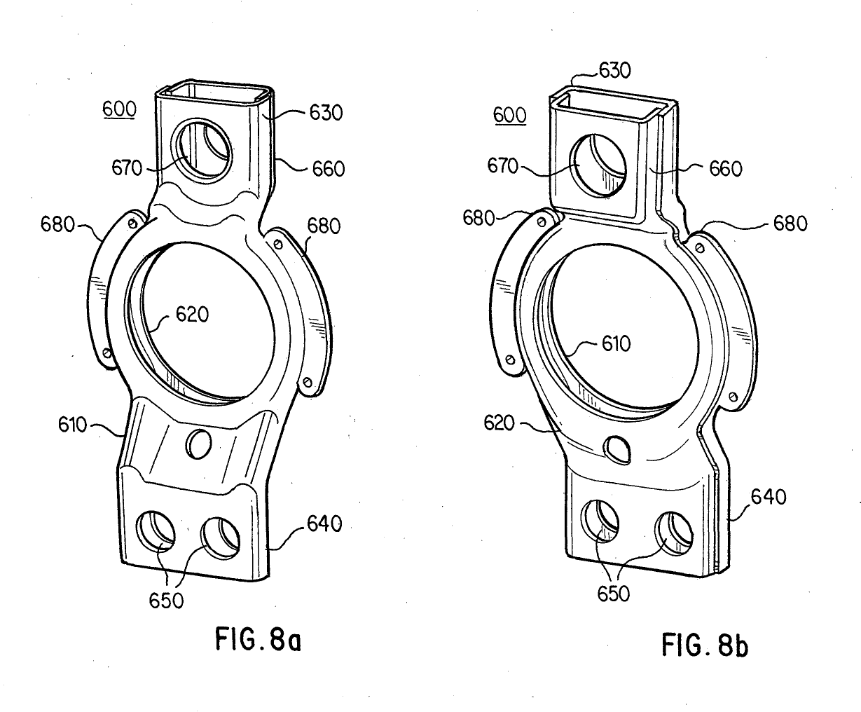

FIG. 7 illustrates an embodiment of a built-up brake spider 501 having anchor pin holes 550, brake actuator rod aperture 570 and axle end hole 590, in which the center region of the spider is provided with a series of bolt holes 502 which may be used to affix the spider to a flange on an axle end (not illustrated) with fasteners such as bolts.

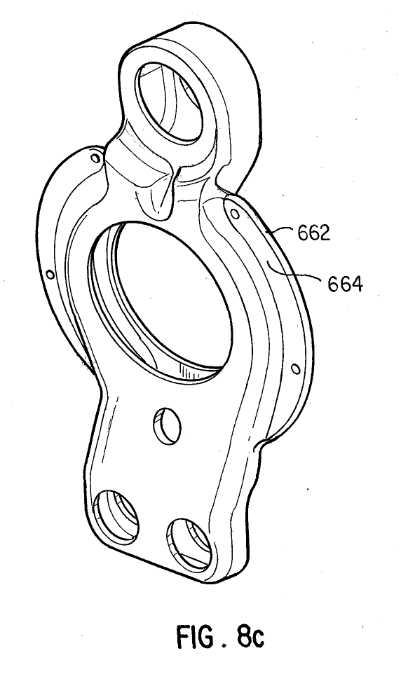

FIGS. 8a and 8b show outboard and inboard, respectively, oblique views of a built-up brake spider 600 in accordance with an embodiment of the present invention, in which an outer shell plate 610 and an inner shell plate 620 are joined by welding along a seam 630 formed at mutually-contacting edge surfaces (in this embodiment, overlapping flanges, as shown at the top of FIGS. 8a and 8b). At an anchor pin end 640, anchor pin support inserts 650 are captured between shell plates 610, 620. Similarly, at an opposite brake actuator rod end 660 of the built-up brake spider, and insert 670 is provided to accommodate a brake actuator rod (not illustrated for clarity). In addition to the deeply drawn portions of the outboard and inboard shell plates, the outer shell plate 610 in this embodiment is provided with lateral extension flanges 680. These flanges may be utilized for securing additional components to the built-up brake spider, such as serving as mounting points for a brake dust shield at low cost (the flanges being easily formed as part of a brake spider plate stamping operation, and thus not requiring additional production cost and complexity, such as with welding of separate tabs or flanges to the brake spider. The flanges could be formed on either the outer shell plate or the inner shell plate, formed by complementary surfaces on both spider shell plates (for example, mating outer flange shell 662 to inner plate 664 in FIG. 8c), or may be entirely separate pieces which are fixed to one or both of the shell plates.

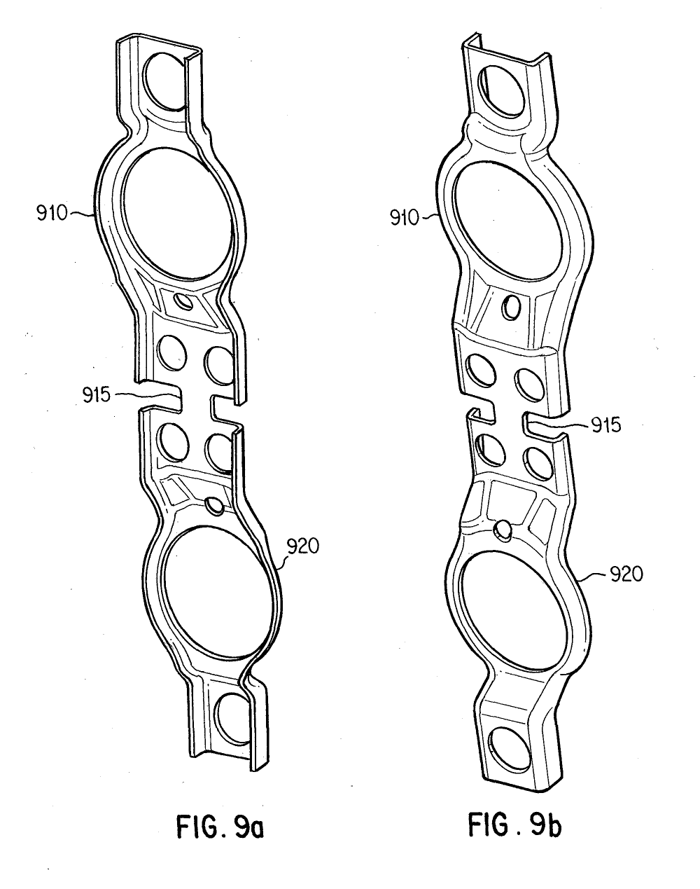

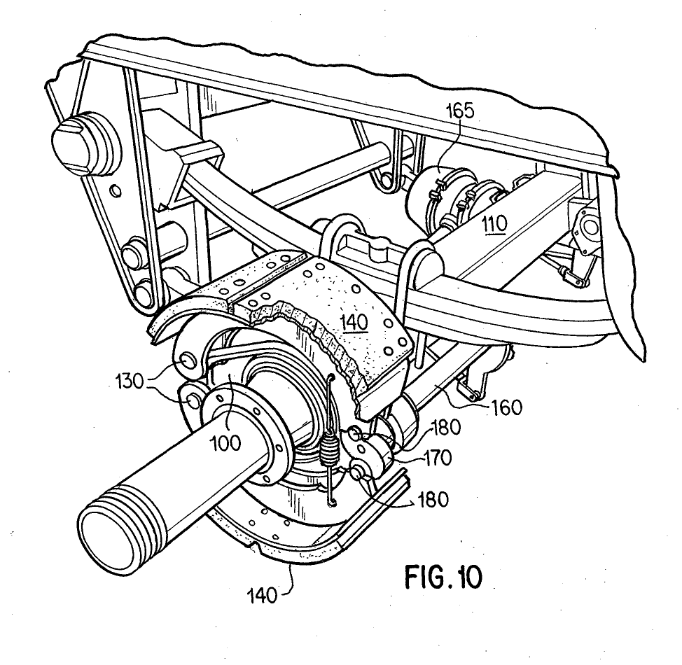

FIGS. 9a-9b are oblique views of a further embodiment of the present invention, in which the outer shell plate 910 and inner shell plate 920 are formed in one piece, with a connecting section 915 connecting the shell plates to one another. Advantageously, brake spider shell plates formed in this manner may be produced in a single forming operation, such as a single stamping operation, to lower manufacturing costs, and then the shell plates may be separated for later positioning to be joined, or may be bent about connecting section 915 to bring the shell plates' corresponding mating surfaces adjacent to one another to form the basic shape of the built-up brake spider.

The foregoing disclosure has been set forth merely to illustrate the invention and is not intended to be limiting. For example, one or more stamped shell elements may itself be built-up from a plurality of components, such as two or more partial stampings, or partial stampings joined with additional components such as reinforcing fillets and/or forged or cast pieces with complicated contours which cannot be cost-effectively stamped. Because other such modifications of the disclosed embodiments incorporating the spirit and substance of the invention may occur to persons skilled in the art, the invention should be construed to include everything within the scope of the appended claims and equivalents thereof.

What is claimed is:

1. A brake spider assembly, comprising:
a first spider shell element; and
a second spider shell element,
wherein
a peripheral edge of the first spider shell element is formed to conform to a peripheral edge of the second spider shell element such that when the respective peripheral edges are adjacent to one another the spider shell elements form a hollow box structure, and
the spider shell elements have apertures which, when the elements are adjacent to one another, align to form an axle pass-through hole for receiving an axle end.

2. The brake spider assembly of claim 1, wherein
the spider shell elements are joined to one another about their peripheral edges.

3. The brake spider assembly of claim 2, wherein the spider shell elements are joined at their peripheral edges by at least one of welding, brazing, clamping, fasteners and adhesive.

4. The brake spider assembly of claim 3, wherein
the spider shell elements each have at least one aperture at an anchor pin end of each spider shell element to receive an anchor pin and an aperture at a brake actuator end of each element to receive a brake actuator rod, and
when the spider shell elements are adjacent to one another, the at least one anchor pin end aperture of both spider shell elements are concentrically aligned and the brake actuator end apertures of both spider shell elements are concentrically aligned.

5. The brake spider assembly of claim 4, further comprising:
at least one of an anchor pin insert and a brake actuator rod support element,
wherein the at least one anchor pin insert and brake actuator rod support element is captured between the first spider shell element and the second spider shell element with a longitudinal axis concentric with one of the spider shell element apertures.

6. The brake spider assembly of claim 5, wherein
in a portion of the at least one anchor pin insert and brake actuator rod support element located between the spider shell elements, there is at least one projection extending radially outward a distance greater than the adjacent aperture, such that the at least one anchor pin insert and brake actuator rod support element is secured against axial displacement out of the spider assembly.

7. The brake spider assembly of claim 6, wherein
the at least one anchor pin insert projection is at least one of a separate ring member installed about a periphery of the anchor pin insert and a region of the anchor pin assembly having a circumference grater than the at least one spider shell element anchor pin aperture.

8. The brake spider assembly of claim 4, further comprising:
at least one of an anchor pin insert and a brake actuator rod support element,
wherein the at least one anchor pin insert and brake actuator rod support element is secured to at least one of the first spider shell element and the second spider shell element by at least one of welding, brazing, fasteners and adhesive.

9. The brake spider assembly of claim 6, wherein
the at least one anchor pin insert and brake actuator rod support element is secured to at least one of the first spider shell element and the second spider shell element by at least one of welding, brazing, fasteners and adhesive.

10. The brake spider assembly of claim 4, wherein
a concentric bushing is located within an inner cylindrical surface of the at least one of an anchor pin insert and a brake actuator rod support element.

11. The brake spider assembly of claim 4, wherein
the spider shell elements have a pattern of concentric holes about the axle pass-through hole for receiving an axle end arranged to permit securing of the brake spider on an axle end with fasteners.

12. The brake assembly of claim 5, wherein
the at least one anchor pin insert and brake actuator rod support element includes an anchor pin assembly having anchor pin projection extending outward from at least a brake assembly side of the brake spider.

13. The brake assembly of claim 5, wherein
the at least one anchor pin insert and brake actuator rod support element includes an anchor pin assembly having anchor pin projecting through a longitudinal center of the anchor pin assembly from a region on an axle side of the brake spider to a brake assembly side of the brake spider.

14. The brake spider of claim 1, wherein
at least one of the spider shell elements is built up from a plurality of shell components.

15. The brake spider assembly of claim 1, wherein
the hollow box structure brake spider is built up from a plurality of stamped spider shell elements.

16. A brake assembly, comprising:
a pair of brake shoes configured to contact an inner surface of a brake drum when pressed radially outward from a rest position, said brake shoes each having an anchor end configured to rotate about an anchor pin;
a brake actuator rod having a cam actuator configured to press cam ends of the brake shoes outward when the brake actuator rod is rotated; and
a brake spider assembly, the brake spider assembly including:
a first spider shell element, a second spider shell element and at least one of an anchor pin insert and a brake actuator rod support element,
wherein
a peripheral edge of the first spider shell element is formed to conform to a peripheral edge of the second spider shell element such that when the respective peripheral edges are adjacent to one another the spider shell elements form a hollow box structure,
the spider shell elements have apertures which, when the elements are adjacent to one another, align to form an axle pass-through hole for receiving an axle end,
the spider shell elements each have at least one aperture at an anchor pin end of each spider shell element to receive an anchor pin and an aperture at a brake actuator end of each element to receive a brake actuator rod,
the at least one anchor pin insert and brake actuator rod support element is captured between the first spider shell element and the second spider shell element with a longitudinal axis concentric with one of the spider shell element apertures, and
the anchor pin projects outward from an outboard face of the brake spider, at least one of the brake shoes is located on the anchor pin, and the brake actuator rod passes through the brake spider such that the brake shoe cam actuator is positioned to press the cam ends of the brake shoes outward when the brake actuator rod is rotated.

17. An axle assembly, comprising:
an axle;
a brake assembly located on an end of the axle;
a brake drum assembly, the brake drum assembly including:
a pair of brake shoes configured to contact an inner surface of the brake drum when pressed radially outward from a rest position, said brake shoes each having an anchor end configured to rotate about an anchor pin;
a brake actuator rod having a cam actuator configured to press cam ends of the brake shoes outward when the brake actuator rod is rotated; and
a brake spider assembly, the brake spider assembly including:
a first spider shell element, a second spider shell element and at least one of an anchor pin insert and a brake actuator rod support element, wherein
a peripheral edge of the first spider shell element is formed to conform to a peripheral edge of the second spider shell element such that when the respective peripheral edges are adjacent to one another the spider shell elements form a hollow box structure,
the spider shell elements have apertures which, when the elements are adjacent to one another, align to form an axle pass-through hole for receiving an axle end,
the spider shell elements each have at least one aperture at an anchor pin end of each spider shell element to receive an anchor pin and an aperture at a brake actuator end of each element to receive a brake actuator rod,
the at least one anchor pin insert and brake actuator rod support element is captured between the first spider shell element and the second spider shell element with a longitudinal axis concentric with one of the spider shell element apertures, and
the anchor pin projects outward from an outboard face of the brake spider, at least one of the brake shoes is located on the anchor pin, and the brake actuator rod passes through the brake spider such that the brake shoe cam actuator is positioned to press the cam ends of the brake shoes outward when the brake actuator rod is rotated.

18. A method of forming a built-up brake spider component, the built-up brake spider including a first spider shell element and a second spider shell element, wherein a peripheral edge of the first spider shell element is formed to conform to a peripheral edge of the second spider shell element such that when the respective peripheral edges are adjacent to one another the spider shell elements form a hollow box structure, and wherein the spider shell elements have apertures which, when the elements are adjacent to one another, align to form an axle pass-through hole for receiving an axle end, comprising:
placing at least one of a brake actuator rod support element and at least one anchor pin insert and between the first spider shell element and the second spider shell element, wherein a longitudinal axis of the at least one of a brake actuator rod support element and at least one anchor pin insert is aligned concentric with the spider shell element apertures;
moving the first spider shell element and the second spider shell elements toward one another to capture the at least one of a brake actuator rod support element and at least one anchor pin insert between the spider shell elements; and
joining the spider shell elements are to one another.
